(19) United States
(12) Patent Application Publication
(10) Pub. No.: US 2023/0378988 A1
(43) Pub. Date: Nov. 23, 2023

(54) PASSIVE RADIO FREQUENCY MIXER WITH VOLTAGE GAIN AND IMPEDANCE MATCHING

(71) Applicant: Apple Inc., Cupertino, CA (US)

(72) Inventors: Linxiao Zhang, San Diego, CA (US); Utku Seckin, San Jose, CA (US); Vikram Magoon, San Jolla, CA (US)

(21) Appl. No.: 17/749,987

(22) Filed: May 20, 2022

(51) Int. Cl. H04B 1/18

(52) U.S. Cl. CPC H04B 1/18

(57) ABSTRACT

This disclosure is directed to a radio frequency front end circuit with improved receiver. The radio frequency front end circuit may include one or more antennas coupled directly to a mixer of the receiver. The mixer may include sampling circuitry to provide sampled signals based on receiving received signals from the one or more antennas. For example, the mixer may provide the sampled signals to a low noise amplifier (LNA) or other downstream components for further processing and/or conditioning. In some cases, the sampling circuitry may include a number of sampling circuits each sampling a portion of a received signal. Moreover, in specific cases, each of the sampling circuits may couple to an impedance matching circuit based on an impedance of the one or more antennas. The mixer may also include various filtering circuits.

### BACKGROUND

The present disclosure relates generally to wireless communication, and more specifically to receivers in wireless communication devices.

In an electronic device, a receiver may be coupled to one or more antennas to enable the electronic device to receive wireless signals. The receiver may include multiple components to filter, sample, and/or amplify received wireless signals. The receiver may then provide a sampled signal to downstream components of the electronic device for further processing or usage. However, the sampled signals may be negatively impacted by noise or interference. Moreover, sampling the received wireless signals may sometimes negatively impact linearity of the received signal. Such impacts may decrease quality of the sampled signals.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, an electronic device includes one or more antennas that receive a radio frequency signal. The electronic device also includes a local oscillator circuit that generates multiple oscillating signals. The electronic device further includes a mixer coupled directly to the one or more antennas. The mixer includes multiple impedance matching circuits coupled to the one or more antennas. Moreover, the mixer includes multiple sampling circuits. Each of the sampling circuits is coupled to a respective impedance matching circuit.

In another embodiment, a radio frequency receiver circuit includes a low noise amplifier and a mixer. The mixer is coupled to the low noise amplifier. The mixer includes multiple impedance matching circuits coupled to one or more antennas. The mixer also includes multiple sampling circuits. Each of the sampling circuits are coupled to a respective impedance matching circuit. Moreover, each sampling circuit receives a radio frequency signal from the one or more antennas, generates a voltage of the radio frequency signal based on an oscillating signal and provides the voltage to the low noise amplifier.

In yet another embodiment, radio frequency signal sampling circuitry includes multiple impedance matching circuits coupled to one or more antennas. The radio frequency signal sampling circuitry also includes multiple sampling circuits. Each sampling circuit is coupled to a respective impedance matching circuit. A first sampling circuit generates a first voltage of a first portion of a radio frequency signal received directly from the one or more antennas based on an impedance of a first impedance matching circuit coupled to the first sampling circuit.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a functional diagram of the electronic device of FIG. 1, according to embodiments of the present disclosure;

FIG. 3 is a schematic diagram of a receiver of the electronic device of FIG. 1, according to embodiments of the present disclosure;

FIG. 4 is a block diagram of a mixer of the receiver of FIG. 3, according to embodiments of the present disclosure;

FIG. 5A is a schematic of a sampling circuit of the mixer of FIG. 3, according to embodiments of the present disclosure;

FIG. 5B is a schematic of the sampling circuit of FIG. 5A when forming a first signal path when receiving a positive local oscillator (LO) signal, according to embodiments of the present disclosure;

FIG. 5C is a schematic of the sampling circuit of FIG. 5A when forming a second signal path when receiving a negative LO signal, according to embodiments of the present disclosure;

FIG. 6 is a graph of a received signal of the sampling circuit of FIG. 5A shown with respect to oscillator signals received by the sampling circuit, according to embodiments of the present disclosure;

FIG. 7 is a schematic of a first impedance matching circuit including a shunt resistor coupled to the sampling circuit of FIG. 5A, according to embodiments of the present disclosure;

FIG. 8 is a schematic of a second impedance matching circuit including a trans-impedance amplifier coupled to the sampling circuit of FIG. 5A, according to embodiments of the present disclosure; and

FIG. 9 is a graph of frequency responses of the mixer of FIG. 4 including the sampling circuit of FIG. 5A and the trans-impedance amplifier of FIG. 8, according to some embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on.

This disclosure is directed to improved sampling of Radio Frequency (RF) signals received by one or more antennas. An electronic device may include a Radio Frequency Front End (RFFE) circuit to communicate RF signals. The RFFE circuit may include one or more antennas and a transceiver. The one or more antennas may receive and provide RF signals to a receiver of the transceiver for sampling and conditioning. The receiver may include circuitry disposed at multiple cascaded stages for sampling voltages of a received RF signal to provide a sampled signal. However, the sampled signal may be degraded if the receiver does not compensate for noise and/or interference.

To reduce the noise and/or interference of the sampled signal, the receiver may include voltage sampling passive mixer circuitry, hereinafter referred to as a mixer, positioned at a first stage of the multiple cascaded stages. The mixer may couple to the one or more antennas (or an antenna circuit). Accordingly, the one or more antennas may provide the received signals directly to the mixer, for example, without an intermediate component or device between the one or more antennas and the mixer, such as a low noise amplifier. The mixer may include sampling circuitry and impedance matching circuitry. In some cases, a mixer chip may include the sampling circuitry and the impedance matching circuitry. Alternatively, the sampling circuitry and the impedance matching circuitry may be positioned in separate chips.

The sampling circuitry and the impedance matching circuitry may include passive components to generate sampled voltages of the received signals. That is, the passive components (e.g., passive resistors, capacitors, non-biased transistors, among other things) may not couple to a voltage supply circuit and may not receive a supply voltage in order to operate. The sampling circuitry may improve linearity of the sampled voltages by sampling the received signals at the first stage of the receiver using passive components. Moreover, the sampling circuitry may include a number of sampling circuits. Each sampling circuit of the sampling circuitry may sample a voltage of a different phase (e.g., a different portion) of the received signals. For example, each sampling circuit may sample a voltage of a different phase of the received signals based on receiving a time-shifted local oscillator (LO) signal.

A voltage-controlled oscillator (VCO) may provide the LO signals (e.g., local oscillation signals) to different sampling circuits of the sampling circuitry based on different time delays (e.g., the LO signals may be time-shifted). Accordingly, each sampling circuit of the sampling circuitry may sample a voltage of a different phase of a received signal (e.g., a different portion of a received signal) when receiving the time-shifted LO signals. Moreover, the VCO may provide the LO signals to each sampling circuit cyclically or periodically based on a wavelength of the received signal. For example, the VCO may provide successive LO signals to a sampling circuit based on half wavelength of the received signal. Furthermore, the VCO may provide the cyclic LO signals to each sampling circuit with alternating positive and negative voltages. Accordingly, a sampling circuit may receive positive and negative LO signals alternatively and cyclically (e.g., at every half wavelength of the received signal).

Each sampling circuit may include a number of passive switches and capacitors. The switches of each sampling circuit may receive the LO signals. In some cases, a first set of the switches of each sampling circuit may close in response to receiving the positive LO signals. Moreover, a second set of the switches of each sampling circuit may close in response to receiving the negative LO signals. As such, each sampling circuit may alternatively form a first signal path when the first set of the switches is closed and may form a second signal path when the second set of the switches is closed. The switches may remain open at other times. The sampling circuit may charge or discharge the capacitors to sample a voltage of the received signals based on forming the first signal path or the second signal path.

The sampling circuits may also amplify a voltage amplitude and/or down-convert a frequency of the received signals based on forming the first signal path and the second signal path. In some cases, the sampling circuits may down-convert a frequency of the received signals to a baseband frequency of the RFFE circuit. For example, each sampling circuit may step a sampled voltage successively through multiple capacitors based on forming the first signal path and the second signal path. Moreover, each of the capacitors of the sampling circuits may accumulate electrical charges of a received signal and one or more previously charged capacitors.

In one embodiment, a first sampling circuit of the sampling circuitry may successively form the first signal path and the second signal path (e.g., form the first signal path at a first time, and form the second signal path at a second time) based on receiving the LO signals to provide a sampled voltage of a received signal. The first sampling circuit may amplify the sampled voltage based on the number of the capacitors being successively and cumulatively charged when receiving the LO signals. Moreover, the first sampling circuit may provide the sampled voltage with a lower frequency (e.g., baseband frequency) based on stepping the sampled voltage through the capacitors of the sampling circuit when receiving the LO signals.

Similarly, one or more remaining sampling circuits (e.g., a second sampling circuit, a third sampling circuit, and so on) of the sampling circuitry may perform similar operations to provide a sampled voltage of the received signal when receiving the LO signals based on different time delays. For example, the sampling circuits of the sampling circuitry may perform such operations to provide sampled voltages of one wavelength of the received signal. Moreover, each of the sampling circuits of the sampling circuitry may perform the operations iteratively based on the wavelength of the received signal and upon receiving the LO signals to provide sampled voltages of successive wavelength of the received signal.

In any case, the impedance matching circuit may increase a real impedance of the mixer to match or correlate to a real impedance of the one or more antennas. In some cases, the impedance matching circuit may include a shunt resistor to increase the real impedance of the mixer. In alternative or additional embodiments, the impedance matching circuit may include a voltage amplifier circuit with increased real impedance. The voltage amplifier circuit may amplify the voltage of the received signal while increasing the real impedance of the mixer. Accordingly, the voltage amplifier circuit may reduce a noise that may otherwise be introduced based on the increased resistance of the mixer. In other cases, the impedance matching circuit may include other viable circuitry to increase the real impedance of the mixer.

FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive data between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer (e.g., in the form of a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (e.g., in the form of a model of an iPhone® available from Apple Inc. of Cupertino, California), a tablet (e.g., in the form of a model of an iPad® available from Apple Inc. of Cupertino, California), a wearable electronic device (e.g., in the form of an Apple Watch® by Apple Inc. of Cupertino, California), and other similar devices. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector provided by Apple Inc. of Cupertino, California, a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, long term evolution (LTE®) cellular network, long term evolution license assisted access (LTE-LAA) cellular network, 5th generation (5G) cellular network, and/or New Radio (NR) cellular network, a satellite network, a non-terrestrial network, and so on. In particular, the network interface 26 may include, for example, one or more interfaces for using a Release-15 cellular communication standard of the 5G specifications that include the millimeter wave (mmWave) frequency range (e.g., 24.25-300 gigahertz (GHz)) and/or any other cellular communication standard release (e.g., Release-16, Release-17, any future releases) that define and/or enable frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

As illustrated, the network interface 26 may include a transceiver 30. In some embodiments, all or portions of the transceiver 30 may be disposed within the processor 12. The transceiver 30 may support transmission and receipt of various wireless signals via one or more antennas, and thus may include a transmitter and a receiver. The power source 29 of the electronic device 10 may include any suitable source of power, such as a rechargeable lithium polymer (Li-poly) battery and/or an alternating current (AC) power converter.

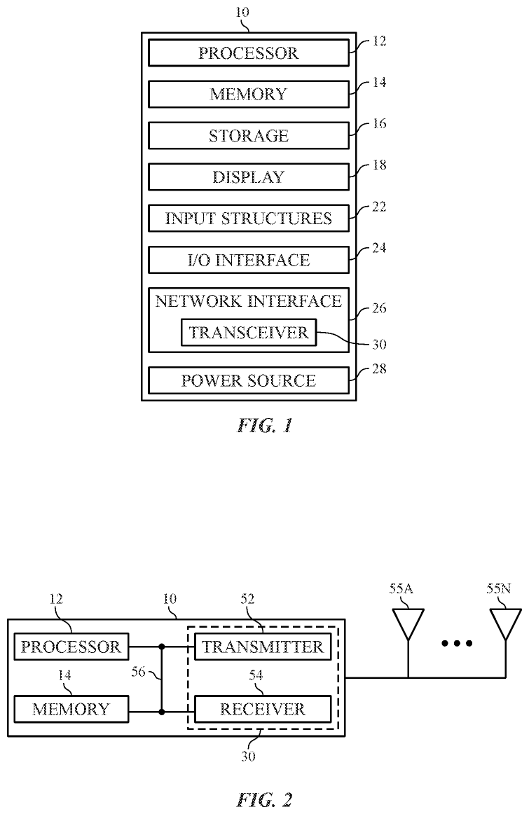

FIG. 2 is a functional diagram of the electronic device 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55) may be communicatively coupled directly or indirectly (e.g., through or via another component, a communication bus, a network) to one another to transmit and/or receive data between one another.

The electronic device 10 may include the transmitter 52 and/or the receiver 54 that respectively enable transmission and reception of data between the electronic device 10 and an external device via, for example, a network (e.g., including base stations) or a direct connection. As illustrated, the transmitter 52 and the receiver 54 may be combined into the transceiver 30. The electronic device 10 may also have one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with a one or more beams and various configurations. In some embodiments, multiple antennas of the antennas 55A-55N of an antenna group or module may be communicatively coupled a respective transceiver 30 and each emit radio frequency signals that may constructively and/or destructively combine to form a beam. The electronic device 10 may include multiple transmitters, multiple receivers, multiple transceivers, and/or multiple antennas as suitable for various communication standards. In some embodiments, the transmitter 52 and the receiver 54 may transmit and receive information via other wired or wireline systems or means.

As illustrated, the various components of the electronic device 10 may be coupled together by a bus system 56. The bus system 56 may include a data bus, for example, as well as a power bus, a control signal bus, and a status signal bus, in addition to the data bus. The components of the electronic device 10 may be coupled together or accept or provide inputs to each other using some other mechanism.

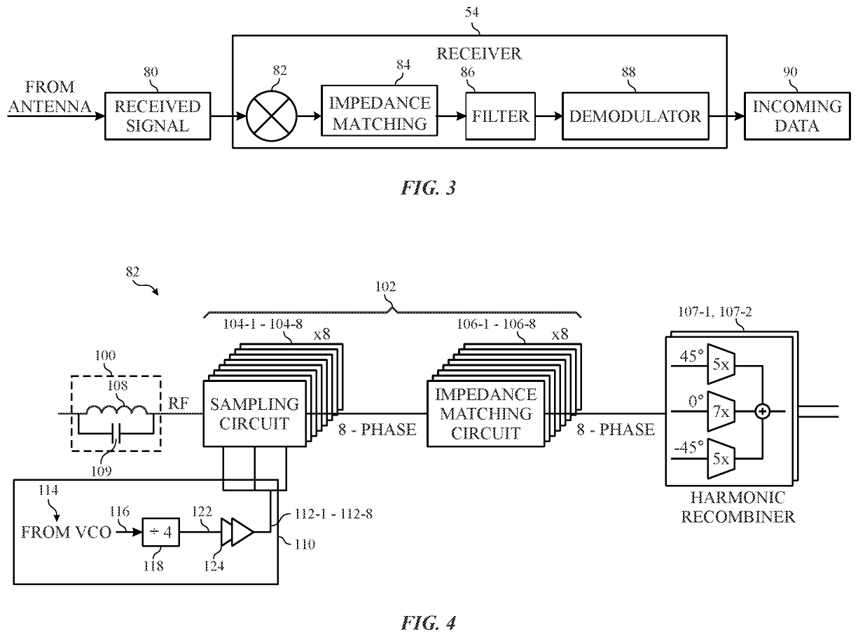

FIG. 3 is a schematic diagram of the receiver 54 (e.g., receive circuitry), according to embodiments of the present disclosure. As illustrated, the mixer 82 may directly couple to the one or more antennas 55. As such, the mixer 82 may directly receive received signal 80 from the one or more antennas 55 in the form of an analog signal. The received signal 80 may have a specific frequency and wavelength. For example, the one or more antennas 55 may receive the received signal 80 over a wireless communication having the specific frequency and/or wavelength.

Moreover, the mixer 82 may include passive electrical components to sample the received signal with improved linearity. Accordingly, the receiver 54 may sample the received signal more linearly based at least in part on the mixer 82 being directly coupled to the one or more antennas 55 and including the passive electrical components. In the depicted embodiment, the mixer 82 may provide a sampled signal to an impedance matching block 84 for subsequent processing. In particular, the impedance matching block 84 may match (e.g., closely match, substantially match, approximately match) or correlate an impedance of one or more components (e.g., sampling circuits) of the mixer 82 with that of the one or more antennas 55.

A filter 86 (e.g., filter circuitry and/or software) may remove undesired noise from the sampled signal, such as cross-channel interference. The filter 86 may also remove additional signals (e.g., additional sampled signals) received by the one or more antennas 55 that are at frequencies other than the desired signal. The filter 86 may include any suitable filter or filters to remove the undesired noise or signals from the received signal, such as a bandpass filter, a bandstop filter, a low pass filter, a high pass filter, and/or a decimation filter.

A demodulator 88 may remove a radio frequency envelope and/or extract a demodulated signal from the filtered signal for processing. Additionally, the receiver 54 may include any suitable additional components not shown, or may not include certain of the illustrated components, such that the receiver 54 may receive the received signal 80 via the one or more antennas 55. For example, the receiver 54 may include amplifiers (e.g., a low noise amplifier), a digital down converter, or additional filters.

Referring now to FIG. 4, a block diagram of the mixer 82 is depicted. The mixer 82 may include multiple cascaded elements including sampling circuitry 102. In some cases, the mixer 82 may include a harmonic trap circuit 100. The harmonic trap circuit 100 may include an inductor 108 and a capacitor 109. For example, the inductor 108 and the capacitor 109 may remove one or more harmonic signals of the received signal 80, at least some of noise signals of the received signal 80, and/or one or more signals outside a desired frequency range (e.g., outside a frequency range of the received signal 80).

In the depicted embodiment, the sampling circuitry 102 may include eight sampling circuits 104-1, 104-2, 104-3, 104-4, 104-5, 104-6, 104-7, and 104-8 (collectively 104) and eight impedance matching circuits 106-1, 106-2, 106-3, 106-4, 106-5, 106-6, 106-7, and 106-8 (collectively 106). The impedance matching circuits 106 may be considered part of the impedance matching block 84 of FIG. 3. However, it should be appreciated that the sampling circuitry 102 may include a different number (e.g., more or less) of sampling circuits 104 and impedance matching circuits 106 in other embodiments. The sampling circuitry 102 may generate sampled voltages of the received signal based on operations of the sampling circuits 104-1, 104-2, 104-3, 104-4, 104-5, 104-6, 104-7, and 104-8. The sampling circuitry 102 may also down-convert a frequency of the received signal to a baseband frequency range. Moreover, the sampling circuitry 102 may amplify a voltage of the received signal when generating the sampled voltages.

Each of the impedance matching circuits 106-1, 106-2, 106-3, 106-4, 106-5, 106-6, 106-7, and 106-8 may couple to one of the sampling circuits 104-1, 104-2, 104-3, 104-4, 104-5, 104-6, 104-7, and 104-8 in series. The impedance matching circuits 106-1, 106-2, 106-3, 106-4, 106-5, 106-6, 106-7, and 106-8 may match (e.g., closely match, substantially match, approximately match) or correlate an impedance of the respective sampling circuits 104-1, 104-2, 104-3, 104-4, 104-5, 104-6, 104-7, and 104-8 with that of the one or more antennas 55, as will be appreciated. Subsequently, the sampling circuitry 102 may provide the sampled voltages to downstream components for further processing.

In some cases, the one or more antennas 55 may include a fixed impedance (e.g., 50 ohms). However, in alternative or additional cases, the one or more antennas 55 may include a variable impedance. Moreover, the sampling circuits 104-1, 104-2, 104-3, 104-4, 104-5, 104-6, 104-7, and 104-8 may each have a similar or different intrinsic impedance (e.g., resistance) based on a voltage of the received signal 80 during a sampling period. For example, the voltage of the received signal 80 may change in different sampling periods based on a phase of the received signal 80 during a respective sampling period. Moreover, the sampling circuits 104-1, 104-2, 104-3, 104-4, 104-5, 104-6, 104-7, and 104-8 may each include a number of components with variable resistance. For example, each of the sampling circuits 104-1, 104-2, 104-3, 104-4, 104-5, 104-6, 104-7, and 104-8 may include one or more switches with varying resistance based on a closed or open state of the switch during each sampling period.

Such varying impedances and/or changing voltages may cause one or more of the sampling circuits 104-1, 104-2, 104-3, 104-4, 104-5, 104-6, 104-7, and 104-8 to provide the sampled voltages with distortion and/or noise. In such cases, matching (e.g., closely matching, substantially matching, approximately matching) or correlating an impedance of the sampling circuits 104-1, 104-2, 104-3, 104-4, 104-5, 104-6, 104-7, and 104-8 with that of the one or more antennas 55 may reduce such distortion and/or noise. For example, one or more of the impedance matching circuits 106-1, 106-2, 106-3, 106-4, 106-5, 106-6, 106-7, and 106-8 may increase the impedance of the respective sampling circuits 104-1, 104-2, 104-3, 104-4, 104-5, 104-6, 104-7, and 104-8 to match or correlate to the impedance of the one or more antennas 55. Accordingly, the impedance matching circuits 106-1, 106-2, 106-3, 106-4, 106-5, 106-6, 106-7, and 106-8 may improve a signal to noise ratio (SNR) of the sampled voltages.

The mixer 82 may also include harmonic recombiners 107-1 and 107-2 to weight (e.g., apply weights to), combine, and/or filter the sampled voltages and generate a sampled signal. The harmonic recombiners 107-1 and 107-2 may couple to the sampling circuitry 102. Moreover, the harmonic recombiners 107-1 and 107-2 may receive the sampled voltages of the received signal 80 from each of the sampling circuits 104-1, 104-2, 104-3, 104-4, 104-5, 104-6, 104-7, and 104-8. The harmonic recombiners 107-1 and 107-2 may combine the sampled voltages to cancel one or more harmonic waveforms when generating the sampled signal of the received signal 80. The harmonic recombiners 107-1 and 107-2 may each receive and combine sampled voltages from at least two of the sampling circuits 104-1, 104-2, 104-3, 104-4, 104-5, 104-6, 104-7, and 104-8 to generate the sampled signal.

In particular, the harmonic recombiners 107-1 and 107-2 may include (e.g., jointly include) eight-phase harmonic recombines associated with each of the eight sampling circuits 104-1, 104-2, 104-3, 104-4, 104-5, 104-6, 104-7, and 104-8. The eight sampling circuits 104-1, 104-2, 104-3, 104-4, 104-5, 104-6, 104-7, and 104-8 may each provide a sampled voltage of a portion of each wavelength (e.g., one full wavelength) of the received signal 80 (e.g., a sampled voltage of a phase of the received signal 80) to the harmonic recombiners 107-1 and 107-2 (e.g., eight-phase harmonic recombiner). The harmonic recombiners 107-1 and 107-2 may perform weight recombination based on receiving the eight portions of each wavelength of the received signal 80. Accordingly, the harmonic recombiners 107-1 and 107-2 may reject at least some of the harmonic waves (e.g., 3rd harmonic, 5th harmonic, and so on) of the sampled voltage.

For example, the harmonic recombiners 107-1 and 107-2 may combine sampled voltages of different phases of the received signal 80 that are 180 degrees out of phase to cancel the harmonic waves. As such, the harmonic recombiners 107-1 and 107-2 may improve a signal integrity and a noise factor (NF) of the sampled signal by cancelling higher order harmonic waves (e.g., 3rd order harmonic, 5th order harmonic, and so on). The harmonic recombiners 107-1 and 107-2 may include active filters, passive filters, harmonic blockers, any combination thereof, as well as any other viable components and circuits to provide a harmonic-reject receiver front-end (HR-RXFE).

As mentioned above, the sampling circuits 104-1, 104-2, 104-3, 104-4, 104-5, 104-6, 104-7, and 104-8 of the sampling circuitry 102 may each sample a portion of each wavelength of the received signal 80. In particular, each of the sampling circuits 104-1, 104-2, 104-3, 104-4, 104-5, 104-6, 104-7, and 104-8 may generate and provide a sampled voltage of the received signal 80 based on receiving local oscillator (LO) signals 112-1, 112-2, 112-3, 112-4, 112-5, 112-6, 112-7, and 112-8. In the depicted embodiment, an LO circuit 110 may provide time-shifted LO signals 112-1, 112-2, 112-3, 112-4, 112-5, 112-6, 112-7, and 112-8 to the sampling circuits 104-1, 104-2, 104-3, 104-4, 104-5, 104-6, 104-7, and 104-8 respectively. The LO circuit 110 may include a voltage-controlled oscillator (VCO) 114, a divider 118, and a delay circuit 124.

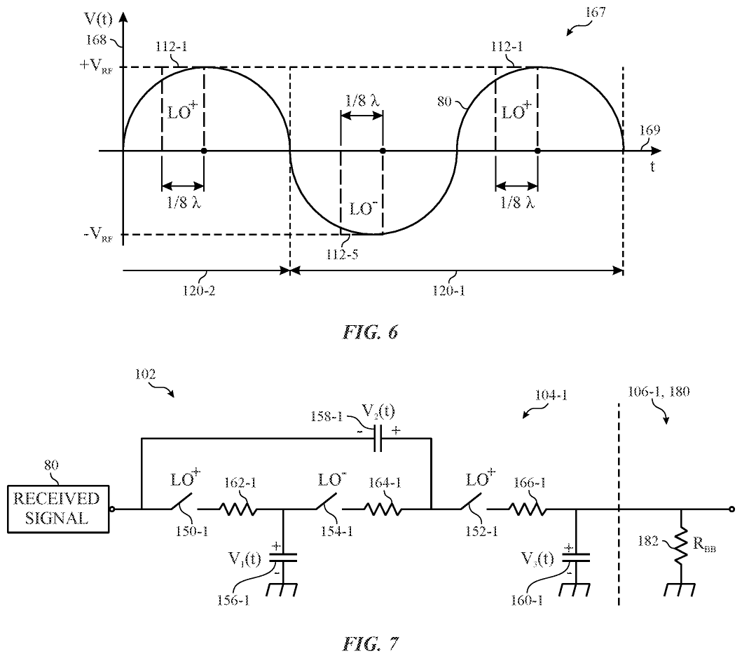

The VCO 114 may provide an oscillating signal 116 to a divider 118. The VCO 114 may provide the oscillating signal 116 based on a frequency and/or a wavelength of the received signal 80. For example, the oscillating signal 116 may have a frequency and/or a wavelength similar to (e.g., equal to, substantially equal to) a frequency and/or a wavelength of the received signal 80. A wavelength 120 (e.g., a first wavelength 120-1 and a second wavelength 120-2) of the received signal 80 is described below with respect to FIG. 6.

Moreover, the divider 118 may divide each positive and negative half of a wavelength of the oscillating signal 116 by a factor of four. As such, the divider 118 may provide eight divided signals 122 associated with the full wavelengths, including the positive and negative halves of the wavelength, of the oscillating signal 116. That is, the eight divided signals 122 may include four positive divided signals 122 and four negative divided signals 122 based on the negative and the positive halves of each wavelength of the oscillating signal 116.

Furthermore, the delay circuit 124 may delay and/or buffer the eight divided signals 122 to provide eight successive LO signals 112-1, 112-2, 112-3, 112-4, 112-5, 112-6, 112-7, and 112-8. The delay circuit 124 of the LO circuit 110 may provide the LO signals 112-1, 112-2, 112-3, 112-4, 112-5, 112-6, 112-7, and 112-8 to the sampling circuits 104-1, 104-2, 104-3, 104-4, 104-5, 104-6, 104-7, and 104-8 respectively and/or successively. Moreover, the sampling circuits 104-1, 104-2, 104-3, 104-4, 104-5, 104-6, 104-7, and 104-8 may each sample a portion of the received signal 80 based on receiving one of the LO signals 112-1, 112-2, 112-3, 112-4, 112-5, 112-6, 112-7, and 112-8. Accordingly, the LO signals 112-1, 112-2, 112-3, 112-4, 112-5, 112-6, 112-7, and 112-8 may each correspond to a sampling period of a wavelength of the oscillating signal 116.

In any case, the sampling circuits 104-1, 104-2, 104-3, 104-4, 104-5, 104-6, 104-7, and 104-8 may each receive one of the LO signals 112-1, 112-2, 112-3, 112-4, 112-5, 112-6, 112-7, and 112-8 successively during a wavelength of the received signal 80. Accordingly, each of the sampling circuit 104-1, 104-2, 104-3, 104-4, 104-5, 104-6, 104-7, and 104-8 may sample a different portion (e.g., a different phase) of the received signal 80 based on receiving the LO signals 112-1, 112-2, 112-3, 112-4, 112-5, 112-6, 112-7, and 112-8.

In some cases, a duty cycle of the LO signals 112-1, 112-2, 112-3, 112-4, 112-5, 112-6, 112-7, and 112-8 may be based on a number of sampling circuits 104-1, 104-2, 104-3, 104-4, 104-5, 104-6, 104-7, and 104-8 and a wavelength of the received signal 80. Alternatively or additionally, the LO circuit 110 may provide the LO signals 112-1, 112-2, 112-3, 112-4, 112-5, 112-6, 112-7, and 112-8 with a different duty cycle. As discussed above, the sampling circuitry 102 of the mixer 82 may include eight sampling circuits 104-1, 104-2, 104-3, 104-4, 104-5, 104-6, 104-7, and 104-8. Accordingly, the LO circuit 110 of such mixer 82 may provide the LO signals 112-1, 112-2, 112-3, 112-4, 112-5, 112-6, 112-7, and 112-8 with a duty cycle equal to or close to 12.5% (or ⅛^{th}) of the wavelength of the received signal 80. For example, the processor 12 and/or the transceiver 30 may automatically determine or may use pre-set information to determine the wavelength of the received signal 80.

In some cases, the mixer 82 may receive the RF signals with a specific frequency band (e.g., LTE signals, 5G NR signals, Bluetooth, Global Navigation Satellite System (GNSS) signals, Global Positioning System (GPS) signals, and so on). For example, the one or more antennas 55 may receive the RF signal having a specific frequency or within a specific frequency range. Alternatively or additionally, the LO circuit 110 may provide the time-shifted LO signals 112-1, 112-2, 112-3, 112-4, 112-5, 112-6, 112-7, and 112-8 with a different duty cycle to each of the eight sampling circuits 104-1, 104-2, 104-3, 104-4, 104-5, 104-6, 104-7, and 104-8. In any case, the sampling circuitry 102 may sample the entirety of the received signal 80 based on each of the eight sampling circuits 104-1, 104-2, 104-3, 104-4, 104-5, 104-6, 104-7, and 104-8 sampling a voltage associated with a different portion (e.g., ⅛^{th}) of the wavelength of the received signal 80.

In some embodiments, each of the sampling circuits 104-1, 104-2, 104-3, 104-4, 104-5, 104-6, 104-7, and 104-8 may receive the LO signals 112-1, 112-2, 112-3, 112-4, 112-5, 112-6, 112-7, and 112-8 cyclically. For example, the LO circuit 110 may generate and provide the LO signals 112-1, 112-2, 112-3, 112-4, 112-5, 112-6, 112-7, and 112-8 to each of the sampling circuits 104-1, 104-2, 104-3, 104-4, 104-5, 104-6, 104-7, and 104-8 at intervals of 180 degrees of the wavelength of the received signal 80 (e.g., every half of a wavelength of the received signal 80).

Accordingly, the LO circuit 110 may alternatively provide a positive LO signal and a negative LO signal at consecutive cycles to each of the sampling circuits 104-1, 104-2, 104-3, 104-4, 104-5, 104-6, 104-7, and 104-8. For example, the LO circuit 110 may provide a positive LO signal using a positive voltage at a first cycle and may provide a negative LO signal using a negative voltage at a next cycle. Accordingly, the LO circuit 110 may alternatively provide the positive LO signals and the negative LO signals that are 180 degrees out of phase to each of the sampling circuits 104-1, 104-2, 104-3, 104-4, 104-5, 104-6, 104-7, and 104-8 based on the wavelength of the received signal.

In different embodiments, the harmonic trap circuit 100, the sampling circuits 104-1, 104-2, 104-3, 104-4, 104-5, 104-6, 104-7, and 104-8, the impedance matching circuits 106-1, 106-2, 106-3, 106-4, 106-5, 106-6, 106-7, and 106-8, and the harmonic recombiners 107-1 and 107-2 of the mixer 82 may be part of an electronic chip (e.g., integrated circuit) or multiple separate electronic chips. In any case, the mixer 82 may couple to the one or more antennas 55 to receive the received signal 80. Moreover, the mixer 82 may provide the sampled signal to downstream components of the electronic device 10 for further processing and/or conditioning. Aspects of the sampling circuits 104-1, 104-2, 104-3, 104-4, 104-5, 104-6, 104-7, and 104-8, the impedance matching circuits 106-1, 106-2, 106-3, 106-4, 106-5, 106-6, 106-7, and 106-8, are described in further detail below.

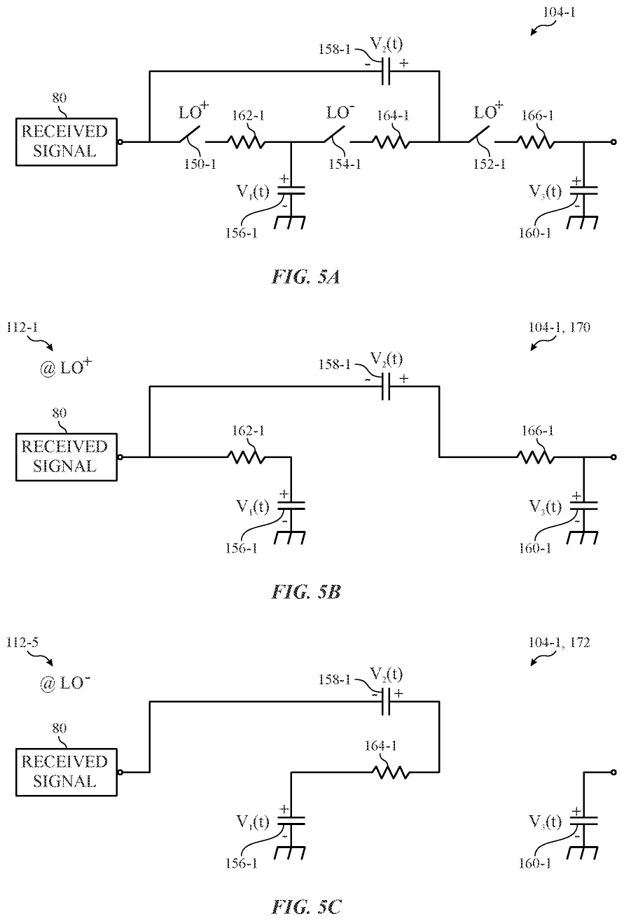

FIG. 5A depicts a schematic of the sampling circuit 104-1. For example, the sampling circuits 104-2, 104-3, 104-4, 104-5, 104-6, 104-7, and 104-8 (not shown) may each be based on or include a similar schematic. The sampling circuit 104-1 may include switches 150-1, 152-1, and 154-1 and capacitors 156-1, 158-1, and 160-1. The sampling circuit 104-1 may also include resistors 162-1, 164-1, and 166-1. In some cases, the resistors 162-1, 164-1, and 166-1 may include intrinsic resistance or resistive elements of the sampling circuit 104-1 (e.g., intrinsic resistance of transmission liens of the sampling circuit 104-1). The sampling circuit 104-1 may store a voltage of the received signal 80 at a first cycle of the sampling circuit 104-1 and generate a sampled voltage at one or more subsequent cycles of the sampling circuit 104-1, as will be appreciated.

In the depicted embodiment, the switches 150-1, 152-1, and 154-1 of the sampling circuit 104-1 may receive a positive LO signal 112-1 (LO+) and a negative LO signal 112-5 (LO−) at consecutive cycles when receiving each wavelength 120 (e.g., the first wavelength 120-1, the second wavelength 120-2, and so on) of the received signal 80. As mentioned above, the first wavelength 120-1 and a half (e.g., positive half) of the second wavelength 120-2 are illustrated in a graph 167 of FIG. 6. The graph 167 depicts a voltage 168 of the received signal 80 and the positive and negative LO signals 112-1 and 112-5 over time 169. In any case, the switches 150-1 and 152-1 may close when receiving the positive LO signal 112-1. Furthermore, the switch 154-1 may close when receiving the negative LO signal 112-5. The switches 150-1, 152-1, and 154-1 may remain open at other times.

In FIG. 5B, the sampling circuit 104-1 may form a first signal path 170 when receiving the positive LO signal 112-1 during a first sampling period. A duration of the first sampling period may correspond to a duration of a duty cycle of the positive LO signal 112-1. The sampling circuit 104-1 may form the first signal path 170 based on closing the switches 150-1 and 152-1 opening the switch 154-1. Moreover, it should be appreciated that the remaining sampling circuits 104-2, 104-3, 104-4, 104-5, 104-6, 104-7, and 104-8 of the sampling circuitry 102 may similarly form the first signal path 170 when receiving a positive LO signal (e.g., the LO signal 112-2) during a respective sampling period.

Moreover, in FIG. 5C, the sampling circuit 104-1 may form a second signal path 172 when receiving the negative LO signal 112-5 during a second sampling period. A duration of the second sampling period may correspond to a duration of a duty cycle of the negative LO signal 112-5. The sampling circuit 104-1 may form the second signal path 172 based on closing the switch 154-1 and opening the switches 150-1 and 150-2. Similarly, it should be appreciated that the remaining sampling circuits 104-2, 104-3, 104-4, 104-5, 104-6, 104-7, and 104-8 of the sampling circuitry 102 may also form the second signal path 172 when receiving a negative LO signal (e.g., the LO signal 112-6) during a respective sampling period. An example embodiment of the positive and negative LO signals 112-1 and 112-5 is depicted with respect to the first wavelength 120-1 and the second wavelength 120-2 in the graph 167 of FIG. 6.

The capacitors 156-1, 158-1, and 160-1 may charge or discharge based on forming the first signal path 170 or the second signal path 172 during a sampling period. In the depicted embodiment, the capacitors 156-1, 158-1, and 160-1 may form three sampling stages based on switching between the first signal path 170 and the second signal path 172 during successive sampling periods. In such cases, the capacitors 156-1, 158-1, and 160-1 may cumulatively store charges during each consecutive sampling period (e.g., the first sampling period and the second sampling period) to amplify a voltage of the received signal 80.

For example, the capacitor 156-1 may couple to the one or more antennas 55 when the sampling circuit 104-1 forms the first signal path 170 based on receiving the positive LO signal 112-1 during the first sampling period. As such, the capacitor 156-1 may accumulate electrical charges of the received signal 80 during the first sampling period. Accordingly, the capacitor 156-1 may sample (e.g., store) a voltage V₁(t) of the received signal 80 during the first sampling period.

Moreover, the capacitor 158-1 may couple to the one or more antennas 55 and the capacitor 156-1 when the sampling circuit 104-1 forms the second signal path 172 based on receiving the negative LO signal 112-5 during the second sampling period. As depicted, a positive side of the charged capacitor 156-1 may couple to the positive side of the capacitor 158-1 in the second sampling period. As such, the capacitor 158-1 may cumulatively store the electrical charges of the capacitor 156-1 and the electrical charges of the received signal 80 when the sampling circuit 104-1 forms the second signal path 172 based on receiving the negative LO signal 112-5 subsequent to receiving the positive LO signal 112-1.

As illustrated in FIG. 6, the LO circuit 110 may provide the consecutive positive and negative LO signals, such as the LO signals 112-1 and 112-5, 180 degrees out of phase based on the wavelength 120 of the received signal 80. Accordingly, the received signal 80 may be 180 degrees out of phase between the first sampling period and the second sampling period. Accordingly, in some cases, the second capacitor 158-1 may store double the voltage of the sampled portion of the received signal 80 during the second sampling period. For example, the second capacitor 158-1 may store a voltage V₂(t) of the sampled portion of the received signal 80 by cumulatively storing the electrical charges stored on the first capacitor 156-1 (e.g., the voltage V₁(t) stored on the first capacitor 156-1) along with electrical charges of an inverted portion (that is 180 degrees out of phase) of the received signal 80 when receiving the negative LO signal 112-5.

Subsequently, a third capacitor 160-1 of the sampling circuit 104-1 may couple in series to the second capacitor 158-1 and the one or more antennas 55 during a third sampling period. The third capacitor 160-1 may accumulate the electrical charges stored on the second capacitor 158-1 and the electrical charges of the received signal 80 when the sampling circuit 104-1 forms the first signal path 170 based on receiving a positive LO signal 112-1 subsequent to the negative LO signal 112-5. For example, the sampling circuit 104-1 may receive the positive LO signal 112-1 of the second wavelength 120-2 of the received signal 80 subsequent to the negative LO signal 112-5.

Moreover, as mentioned above, the LO circuit 110 may provide the consecutive positive and negative LO signals to each sampling circuit 104-1, 104-2, 104-3, 104-4, 104-5, 104-6, 104-7, and 104-8, 180 degrees out of phase when compared to the wavelength of the received signal 80. As such, the received signal 80 may be 180 degrees out of phase during the third sampling period compared to the second sampling period. Accordingly, when forming the first signal path 170, the third capacitor 160-1 may receive triple the voltage of the sampled portion of the received signal 80 V₃(t) by cumulatively storing the electrical charges stored on the second capacitor 158-1 along with the electrical charges of the received signal 80.

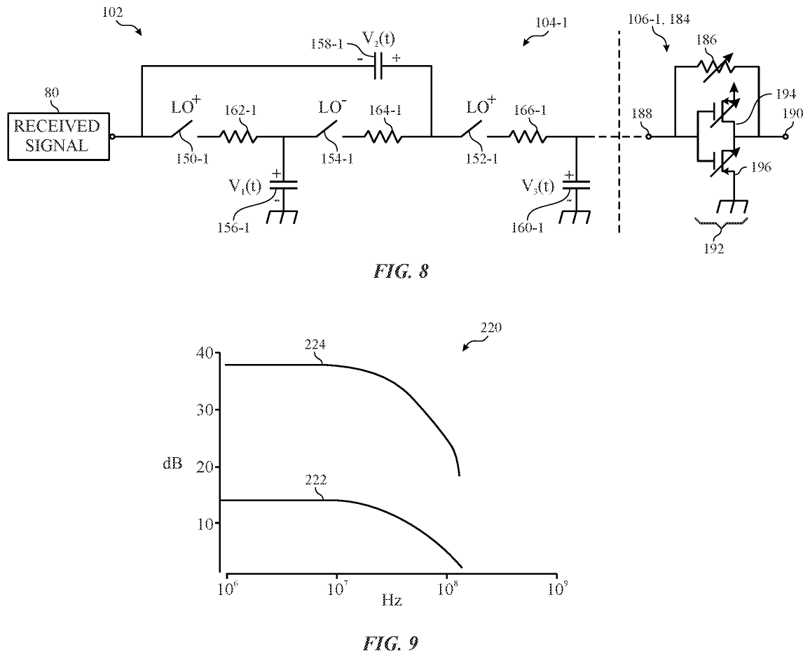

FIGS. 7 and 8 depict different embodiments of the impedance matching circuits 106-1 coupled to the sampling circuit 104-1. As mentioned above, the impedance matching circuits 106-1, 106-2, 106-3, 106-4, 106-5, 106-6, 106-7, and 106-8 may increase an impedance or resistance of the sampling circuitry 102 to match an impedance or resistance of the one or more antennas 55. Accordingly, the impedance matching circuits 106-1, 106-2, 106-3, 106-4, 106-5, 106-6, 106-7, and 106-8 may reduce the distortion and/or noise caused by varying impedances and/or changing voltages (e.g., sampled) of the sampling circuits 104-1, 104-2, 104-3, 104-4, 104-5, 104-6, 104-7, and 104-8.

In particular, in FIG. 7, a first embodiment of the impedance matching circuit 106-1 is depicted including a shunt resistor or resistive element 182. The shunt resistor 182 may increase a total impedance (e.g., real impedance, resistance) of a portion of the sampling circuit 104-1 including the sampling circuit 104-1 and the impedance matching circuits 106-1. The shunt resistor 182 may have a resistance that causes a real impedance of the sampling circuit 104-1 and the impedance matching circuits 106-1 to match a real impedance of the one or more antennas 55. However, in specific cases, increasing the impedance of the sampling circuit 104-1 using a constant resistance may cause fluctuation of the sampled voltage, or otherwise introduce noise to the sampled voltage of the sampling circuit 104-1.

In FIG. 8, a second embodiment of the impedance matching circuit 106-1 is depicted including a trans-impedance amplifier (TIA) 184. The TIA 184 improve (e.g., increase) a gain of the sampled voltage of the received signal 80 during the sampling period while increasing the real impedance of the sampling circuit 104-1. The TIA 184 may filter or reduce an impact of at least some noise of the sampled voltage of the sampling circuit 104-1 based on increasing the gain of the sampled voltage and providing real impedance. Accordingly, the TIA 184 of each of the impedance matching circuits 106-1, 106-2, 106-3, 106-4, 106-5, 106-6, 106-7, and 106-8 may provide amplified sampled voltages with reduced noise.

In some cases, the TIA 184 may increase the real impedance of the sampling circuit 104-1 to match or correlate to the real impedance of the one or more antennas 55 using a resistor 186 (e.g., impedance matching portion) coupled between an input 188 and an output 190 of the TIA 184. Moreover, the TIA 184 may include an amplifier 192 (e.g., amplifier portion) including a transistor 194 and a transistor 196 to improve (e.g., increase) the gain of the sampled voltage of the sampling circuit 104-1.

As mentioned above, in some cases, increasing the real impedance of the sampling circuit 104-1 may increase noise associated with the sampled voltage of the sampling circuit 104-1. The TIA 184 may reduce such noise, or lower a rise of the noise caused by increasing the real impedance of the sampling circuit 104-1, based on improving (e.g., increasing) the gain of the sampled voltage of the sampling circuit 104-1.

In some embodiments, the TIA 184 may also include additional components such as a current source feedback connection between the input 188 and the output 190, one or more resistors, and/or one or more capacitors. For example, such additional components may improve the gain or a noise factor (NF) of the sampled voltage provided to downstream components. In other cases, the impedance matching circuit 106-1 may include other viable circuitry to increase the real impedance and/or gain of the sampling circuit 104-1. Moreover, the sampling circuits 104-2, 104-3, 104-4, 104-5, 104-6, 104-7, and 104-8 (not shown) may also couple to the impedance matching circuit 106-2, 106-3, 106-4, 106-5, 106-6, 106-7, and 106-8 including the shunt resistor 182 or the TIA 184, respectively.

FIG. 9 is a graph 220 depicting frequency responses of the sampling circuit response 222 and the TIA 184, according to some embodiments of the present disclosure. In particular, the graph 220 may include a sampling circuit response 222 and a TIA response 224 shown in decibels (dB) over an example frequency range. For example, the sampling circuits 104-1, 104-2, 104-3, 104-4, 104-5, 104-6, 104-7, and 104-8 may provide the sampled voltages with the sampling circuit response 222 and the TIA 184 may provide the amplified sampled voltages with reduced noises with the TIA response 224.

In the depicted embodiment, the TIA 184 may provide the amplified sampled voltages with reduced noise using a higher gain when compared to that of the sampling circuits 104-1, 104-2, 104-3, 104-4, 104-5, 104-6, 104-7, and 104-8. As discussed above, the TIA 184 may improve (e.g., increase) a gain of the sampled voltages while reducing noise by providing a matching (e.g., closely matching, substantially matching, approximately matching) or correlating real impedance with the one or more antennas 55. In any case, it should be appreciated that the sampling circuit response 222 and the TIA response 224 are provided only as examples and, in different embodiments, the sampling circuit response 222 and the TIA response 224 may have a different frequency response.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. An electronic device comprising:
one or more antennas configured to receive a radio frequency signal;
a local oscillator circuit configured to generate a plurality of oscillating signals; and
a mixer coupled directly to the one or more antennas, the mixer comprising
a plurality of impedance matching circuits coupled to the one or more antennas, and
a plurality of sampling circuits, each sampling circuit of the plurality of sampling circuits coupled to a respective impedance matching circuit of the plurality of impedance matching circuits.

2. The electronic device of claim 1, wherein the local oscillator circuit is configured to generate each oscillating signal of the plurality of oscillating signals at a different time.

3. The electronic device of claim 2, wherein each sampling circuit of the plurality of the sampling circuits is configured to sample a voltage of a portion of the radio frequency signal based on an oscillating signal of the plurality of oscillating signals.

4. The electronic device of claim 1, wherein the local oscillator circuit is configured to generate a number of successive oscillating signals of the plurality of oscillating signals during a time associated with a wavelength of the radio frequency signal, wherein the number of the successive oscillating signals is based on a number of the plurality of sampling circuits.

5. The electronic device of claim 4, wherein each sampling circuit of the plurality of sampling circuits is configured to sample a voltage of a portion of the wavelength of the radio frequency signal based on an oscillating signal of the number of the successive oscillating signals and based on the wavelength of the radio frequency signal.

6. The electronic device of claim 1, wherein an impedance matching circuit of the plurality of impedance matching circuits comprises a shunt resistor.

7. The electronic device of claim 1, wherein an impedance matching circuit of the plurality of impedance matching circuits comprises a trans-impedance amplifier, the trans-impedance amplifier comprising an amplifier portion and an impedance matching portion.

8. The electronic device of claim 1, comprising a number of harmonic recombiner circuits configured to combine a sampled voltage of each of the plurality of the sampling circuits to generate a sampled signal of the radio frequency signal.

9. The electronic device of claim 1, comprising a harmonic trap circuit configured to reduce harmonic waves of the radio frequency signal.

10. A radio frequency receiver circuit, comprising:
a low noise amplifier; and
a mixer coupled to the low noise amplifier, the mixer comprising
a plurality of impedance matching circuits coupled to one or more antennas, and
a plurality of sampling circuits, each sampling circuit of the plurality of sampling circuits coupled to a respective impedance matching circuit of the plurality of impedance matching circuits, each sampling circuit of the plurality of sampling circuits configured to
receive a radio frequency signal from the one or more antennas,
generate a voltage of the radio frequency signal based on an oscillating signal and the radio frequency signal, and
provide the voltage to the low noise amplifier.

11. The radio frequency receiver circuit of claim 10, wherein each sampling circuit of the plurality of sampling circuits comprises a plurality of switches and a plurality of capacitors.

12. The radio frequency receiver circuit of claim 11, wherein each switch of the plurality of switches of each sampling circuit is configured to open or close based on the oscillating signal.

13. The radio frequency receiver circuit of claim 12, wherein each sampling circuit of the plurality of sampling circuits forms a first signal path or a second signal path based on the oscillating signal and each switch of the plurality of switches.

14. The radio frequency receiver circuit of claim 13, wherein each capacitor of the plurality of the capacitors of each sampling circuit is configured to accumulate electrical charges associated with the radio frequency signal based on the first signal path or the second signal path and based on the radio frequency signal.

15. Radio frequency signal sampling circuitry, comprising:
a plurality of impedance matching circuits coupled to one or more antennas, and
a plurality of sampling circuits, each sampling circuit of the plurality of sampling circuits coupled to a respective impedance matching circuit of the plurality of impedance matching circuits, a first sampling circuit of the plurality of sampling circuits configured to generate a first voltage of a first portion of a radio frequency signal received directly from the one or more antennas based on an impedance of a first impedance matching circuit of the plurality of impedance matching circuits coupled to the first sampling circuit.

16. The radio frequency signal sampling circuitry of claim 15, wherein a second sampling circuit of the plurality of sampling circuits is configured to generate a second voltage of a second portion of the radio frequency signal received directly from the one or more antennas based on an impedance of a second impedance matching circuit of the plurality of impedance matching circuits coupled to the second sampling circuit.

17. The radio frequency signal sampling circuitry of claim 15, wherein the first sampling circuit is configured to generate the first voltage of the radio frequency signal based on an oscillating signal from a local oscillator circuit.

18. The radio frequency signal sampling circuitry of claim 15, wherein the first sampling circuit comprises
a first capacitor configured to accumulate first electrical charges associated with the radio frequency signal during a first time when the first sampling circuit receives a first oscillating signal,
a second capacitor configured to accumulate the first electrical charges of the first capacitor and second electrical charges associated with the radio frequency signal during a second time when the first sampling circuit receives a second oscillating signal, and
a third capacitor configured to accumulate the first electrical charges and the second electrical charges of the second capacitor and third electrical charges associated with the radio frequency signal during a third time when the first sampling circuit receives a third oscillating signal.

19. The radio frequency signal sampling circuitry of claim 15, wherein the first sampling circuit comprises a plurality of switches configured to form a first signal path based on a positive oscillating signal and form a second signal path based on a negative oscillating signal.

20. The radio frequency signal sampling circuitry of claim 19, wherein the first sampling circuit is configured to generate a first voltage of the first portion of the radio frequency signal based on the first signal path and the second signal path.
